(19) United States
(12) Patent Application Publication
(10) Pub. No.: US 2012/0043828 A1
(43) Pub. Date: Feb. 23, 2012

(54) UNINTERRUPTIBLE PHOTOSENSING POWER CONTROLLER FOR STREETLIGHT

(76) Inventor: HEN-SHIU PENG, HSINCHU COUNTY (TW)

(21) Appl. No.: 12/857,839

(22) Filed: Aug. 17, 2010

(51) Int. Cl. H05B 37/02

(52) U.S. Cl. 307/117

(57) ABSTRACT

An uninterruptible photosensing power controller for streetlight has a control box and a photosensing device. The control box has two sets of power cables and a socket. One set of power cables is connected to a utility pole and the other set of power cables is connected to a streetlight. The socket serves for the photosensing device to be plugged therein and fixed thereon. The photosensing device triggers the control box according to a luminance level of ambient light to control to supply a power from the utility pole to the streetlight. Since the photosensing device is directly fixed on the control box, the present invention simplifies the process and reduces the labor in installing a conventional power controller for streetlight.

### BACKGROUND OF THE INVENTION

1. Field of the Invention

The present invention is related to a streetlight power controller, and more particularly to a streetlight power controller simplifying wiring procedure and ensuring to constantly turn on streetlight under thunder and lighting in the nighttime.

2. Description of the Related Art

With reference to FIG. 7, a conventional streetlight power controller has a control box 70 and a photosensing device 80. The control box 70 has a power switch (not shown) mounted therein. The photosensing device 80 is electrically connected with the power switch inside the control box 80 by using power wires and sends a sensed luminance level of ambient light to the power controller inside the control box.

The control box 70 has three power cables. Two of the power cables are connected with the power lines 61 (R, N) of a streetlight 60, and the remaining one is connected with photosensing device 80. Similarly, the photosensing device 80 has three power wires. One of the power wires is connected with the control box 70. The rest of two power wires are connected with the power lines 51 (S, N) of a utility pole 50. The control box 70 acquires the power from the power lines 51 of the utility pole through the photosensing device 80. The power is not outputted to the control box 70 unless the luminance level of ambient light sensed by the photosensing device is low. The power switch in the control box further transmits the power to the power lines 61 of the streetlight 60 to turn on the streetlight 60. Hence, when ambient light is bright, the control box 70 receives no power from the power lines 51 and the streetlight 60 goes off.

To acquire the power of the power lines 51 of the utility pole 50, the control box 70 must be connected with the power lines of the streetlight 60 and the photosensing device 80 must be connected with the power lines 51 of the utility pole 50. Therefore, installation workers must carefully pay attention to the wiring correctness. Besides, for sake of being independent devices, the control box 70 and the photosensing device 80 need to be separately fixed on the streetlight pole with a fixing member. With reference to FIG. 8, the photosensing device 80 is fastened on a streetlight pole in collaboration with an inverted-L fixture and the control box 70 is separately fastened on a streetlight pole with screw. Accordingly, an installation worker must separately fix the control box 70 and the photosensing device 80 on the streetlight pole first, then connect the three power wires of the photosensing device with the power lines of the utility pole and the corresponding power cables of the control box 70, and connect the remaining power cables of the control box 70 with the power lines of the streetlight 60. All installation procedures are complicated, time consuming and do not allow to make mistake to the wiring connection.

Other objectives, advantages and novel features of the invention will become more apparent from the following detailed description when taken in conjunction with the accompanying drawings.

### SUMMARY OF THE INVENTION

A first objective of the present invention is to provide a photosensing power controller for streetlight capable of simplifying installation procedures.

To achieve the foregoing objective, the photosensing power controller for streetlight has a control box and a photosensing device.

The control box has a body, a socket, two sets of power cables and a power switch. The socket is mounted on the body. The two sets of power cables are mounted through the body. The power switch is mounted inside the body, is electrically connected with the socket and the two sets of power cables, and has a trigger terminal.

The photosensing device is plugged in the socket of the control box, is electrically connected with the trigger terminal and one set of power cables through the socket, and triggers to switch the power switch in accordance with a luminance level of ambient light.

The socket is mounted on the body and is directly and electrically connected with the power switch inside the control box. Installation workers only need to plug in the photosensing device on the control box in advance and fix the control box on the streetlight pole and further correctly connect the power cables of the control box with the power lines of the utility pole and the streetlight, thereby effectively reducing the procedures and labor of the installation.

A second objective of the present invention is to provide an uninterruptible photosensing power controller for streetlight.

The photosensing device of the uninterruptible photosensing power controller for streetlight has a relay. The relay has a first switch and a second switch. During nighttime, the first and second switches are switched on while the current from the utility pole flows through the first switch without going through the second switch connected with a resistor. When the first switch is damaged by a surge, the second switch provides a backup path to supply power to the streetlight through the first switching unit. The aforementioned power switch further has a second switching unit. The second switching unit has a transfer switch, a normally-open line and a normally-closed terminal. The transfer switch is connected with the trigger terminal and is activated by the first excitation coil of the power switch to selectively connect with the normally-open line or the normally-closed terminal. The control box further has a third switching unit. The third switching unit has a third excitation coil connected with the normally-open line of the second switching unit and a third switch connected between the two sets of power cables.

When the first excitation coil of the power switch breaks down, the third switch is activated to switch on through the second switching unit and provide a path to supply power to the streetlight. Accordingly, even if subjected to thunder and lightening and faulty conditions, the present invention can be continuously triggered to light up the streetlight.

Other objectives, advantages and novel features of the invention will become more apparent from the following detailed description when taken in conjunction with the accompanying drawings.

### BRIEF DESCRIPTION OF THE DRAWINGS

FIG. 1 is a partially exploded view of a first embodiment of an uninterruptible photosensing power controller for streetlight in accordance with the present invention;

FIG. 2 is a perspective view of the uninterruptible photosensing power controller for streetlight in FIG. 1;

FIG. 3 is a schematic view of the uninterruptible photosensing power controller for streetlight in FIG. 1 connected with a utility pole and a streetlight;

FIGS. 4A to 4C are detailed circuit diagrams of the uninterruptible photosensing power controller for streetlight in FIG. 1;

FIG. 5 is a front view of a second embodiment of an uninterruptible photosensing power controller for streetlight in accordance with the present invention;

FIGS. 6A to 6D are detailed circuit diagrams of the uninterruptible photosensing power controller for streetlight in FIG. 5;

FIG. 7 is a schematic view of a conventional power controller for streetlight connected with a utility pole and a streetlight; and

FIG. 8 is a side view of the conventional power controller for streetlight in FIG. 7.

### DETAILED DESCRIPTION OF THE INVENTION

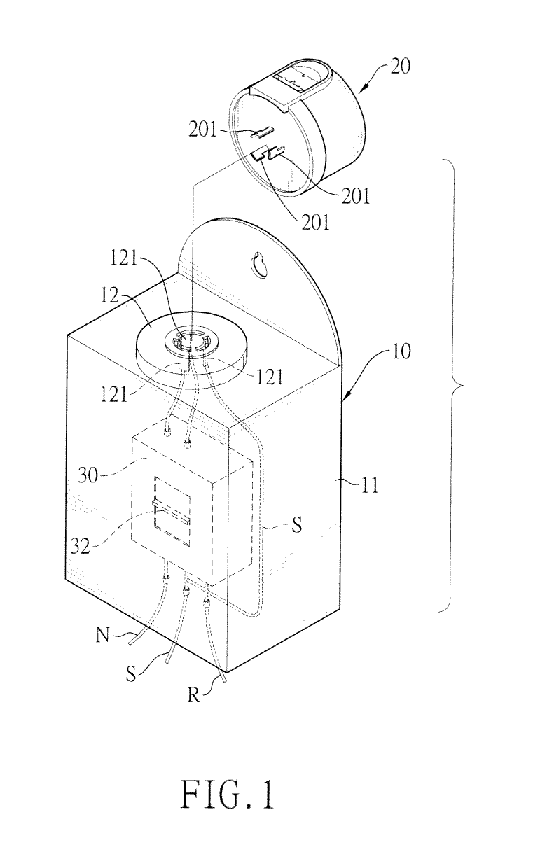

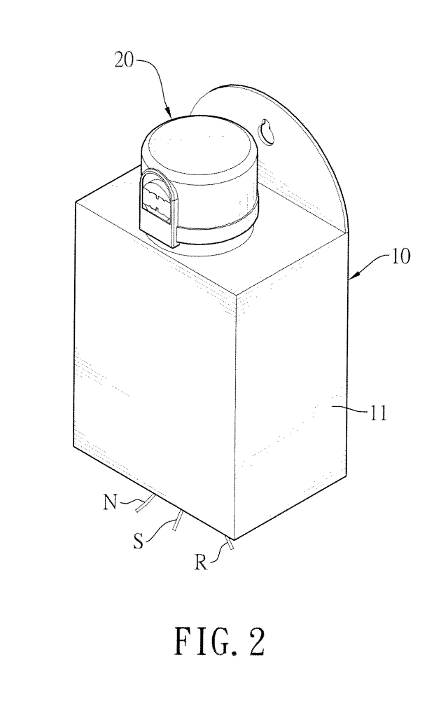

With reference to FIGS. 1 to 3, a first embodiment of an uninterruptible photosensing power controller for streetlight in accordance with the present invention has a control box 10 and a photosensing device 20.

The control box 10 has a body 11, a socket 12, two sets of power cables (S, R, N) and a power switch 30. The socket 12 is mounted on a top of the body and the power cables (S, R, N) are mounted through the body 11. In the first embodiment, the socket 12 has three plug holes 121. One set of power cables (S, N) is adapted to connect with power lines 51 of a utility pole 50. The other set of power cables (R, N) is adapted to connect with power lines of a streetlight. The socket 12 is electrically connected with a trigger terminal (I/P) of the power switch 30 and the set of power cables (S, R, N) connected to the streetlight 60.

The photosensing device 20 is plugged in the socket 12 of the control box 10 and is electrically connected with the trigger terminal (I/P) of the power switch 30 through the socket 12 and triggers the power switch 30 to switch on or off in accordance with a luminance level of ambient light. In the first embodiment, the photosensing device 20 has three blades 201 to correspond to the three plug holes 121 and the three blades 201 are plugged in the three plug holes 121 of the socket 12.

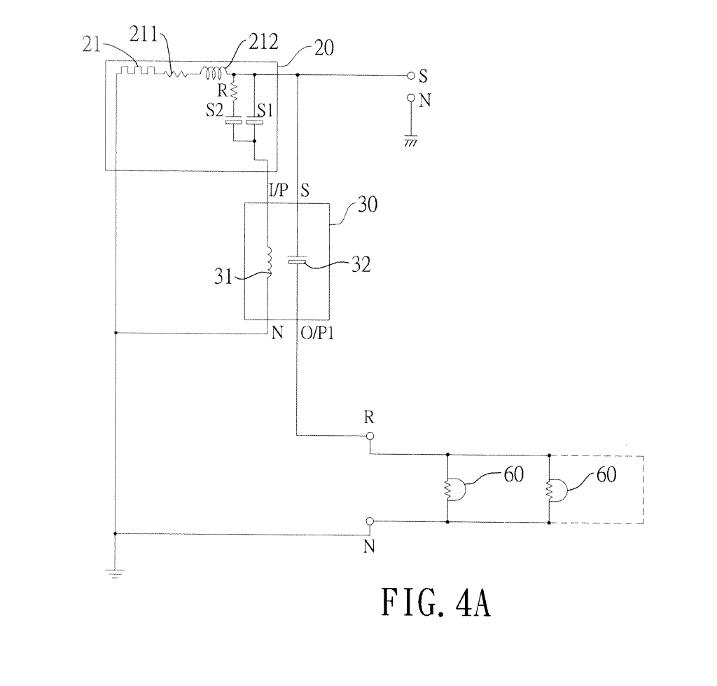

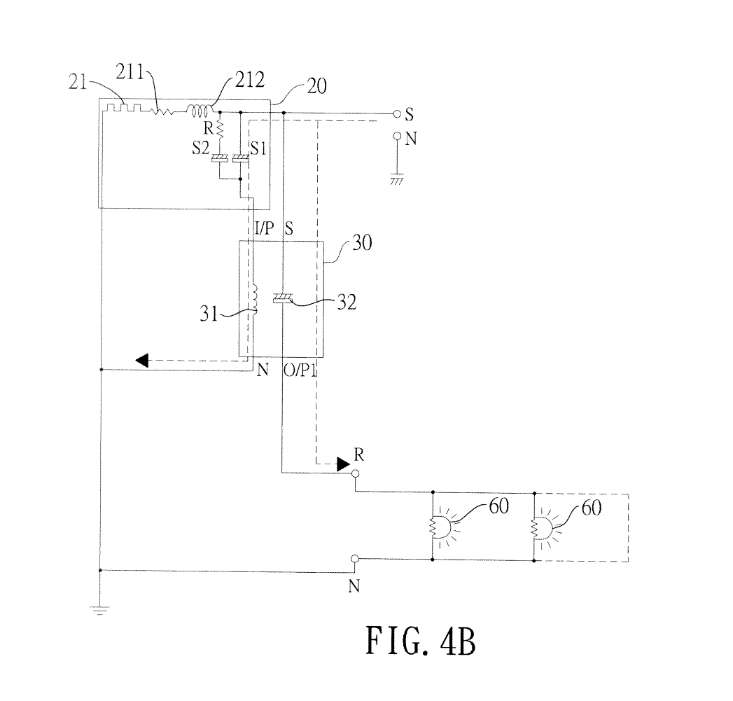

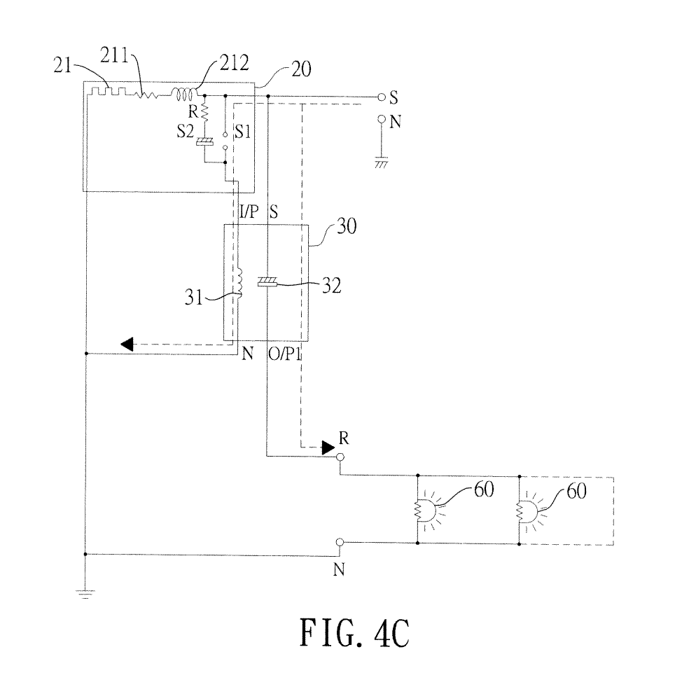

With reference to FIG. 4, the photosensing device 20 has a relay and a photovaristor 21. The relay has an excitation coil 212, a first switch S1 and a second switch S2. The first switch S1 and the second switch S2 are parallelly connected between the power line S connected to the utility pole and the excitation coil 212 and connected with the trigger terminal I/P of the power switch 30. The second switch S2 is serially connected with a resistor R. The photovaristor 21 is serially connected between the S line of the set of power cable connected to the utility pole and the N line of the set of power cable connected to the streetlight 60 through a resistor 211 and the excitation coil 212 of the relay.

The power switch 30 has a first switching unit 32 and a first excitation coil 31. The first switching unit 32 is connected across the S line of the set of power cable connected to the utility pole and the R line of the set of power cable connected to the streetlight 60. One end of the first excitation coil 31 is connected with the trigger terminal I/P and is connected with the first switch S1 and the second switch S2 of the photosensing device 20. The first switching unit 32 is switched on by a current outputted from the first switch S1 or the second switch S2 and flowing through the first excitation coil 31.

During daytime, the photovaristor 21 has a low resistance value (below 50Ω) due to the bright luminance. The excitation coil 212 of the relay is induced so that the first switch S1 and the second switch S2 switch off. Hence, the set of power cable 51 of the utility pole 50 is disconnected from the first switch S1 and the second switch S2. Meanwhile, the first excitation coil 31 of the power switch 30 has no current flowing in, the first switching unit 32 switches off, and the set of power cable connected to the streetlights 60 is disconnected. As a result, the streetlights 60 go off.

With reference to FIG. 4B, during nighttime, the photovaristor 21 has a high resistance value (1MΩ) due to the deficient luminance. The first switch S1 and the second switch S2 of the relay simultaneously switch on. As the second switch is serially connected with the resistor R, a current from the utility pole flows to the trigger terminal I/P of the power switch 30 through the first switch S1 instead of the second switch S2. The first excitation coil 31 of the power switch then activates the first switching unit 32 to switch on to connect to the power cable connected to the streetlight 60. The power of the utility pole is outputted to the streetlight and the streetlight turns on.

With reference to FIG. 4C, when the current of the power of the utility pole 50 increases due to a thunder and lightening in the nighttime, the first switch S1 breaks down but the second switch S2 remains to be on as an alternative power input path. A current flowing through the first excitation coil 31 continuously activates the first switching unit 32 to switch on. Therefore, the power from the utility pole is outputted to the streetlights 60 through the first switching unit 32.

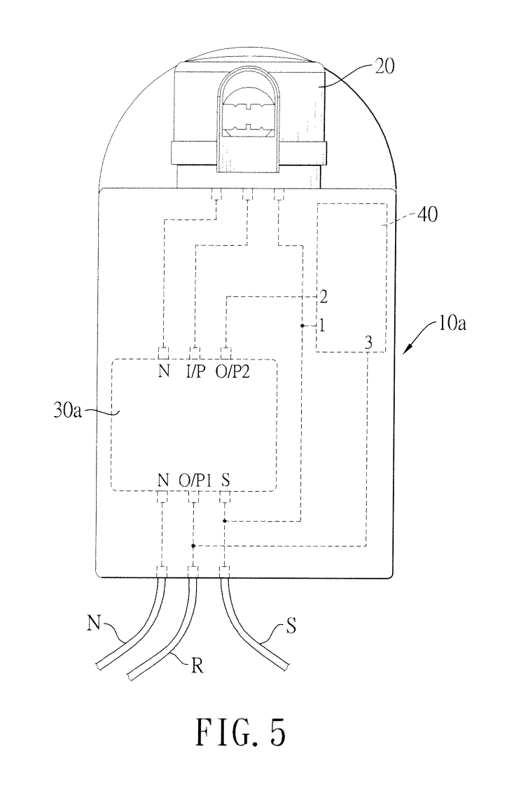

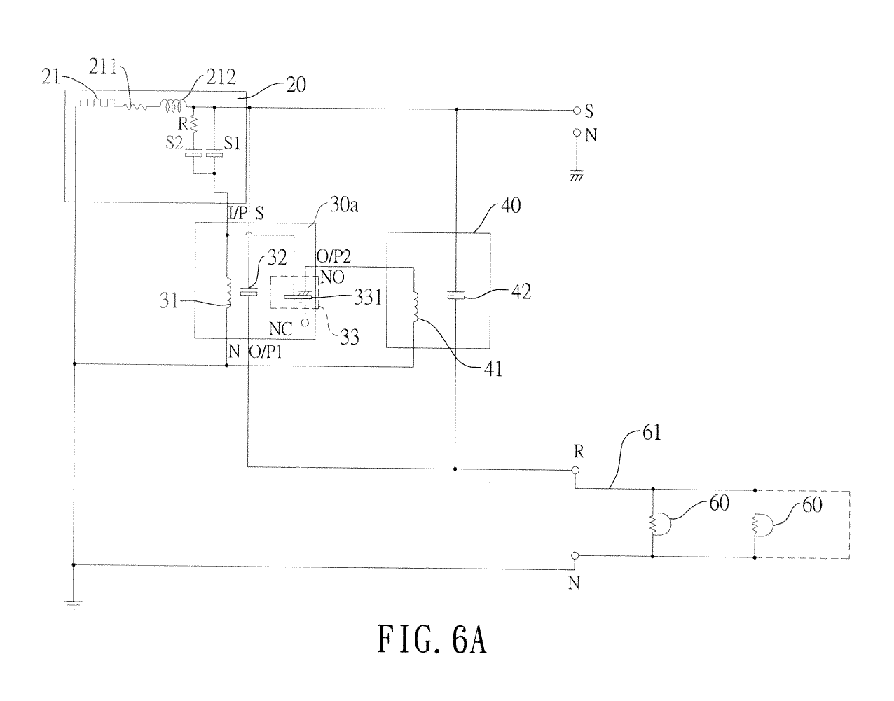

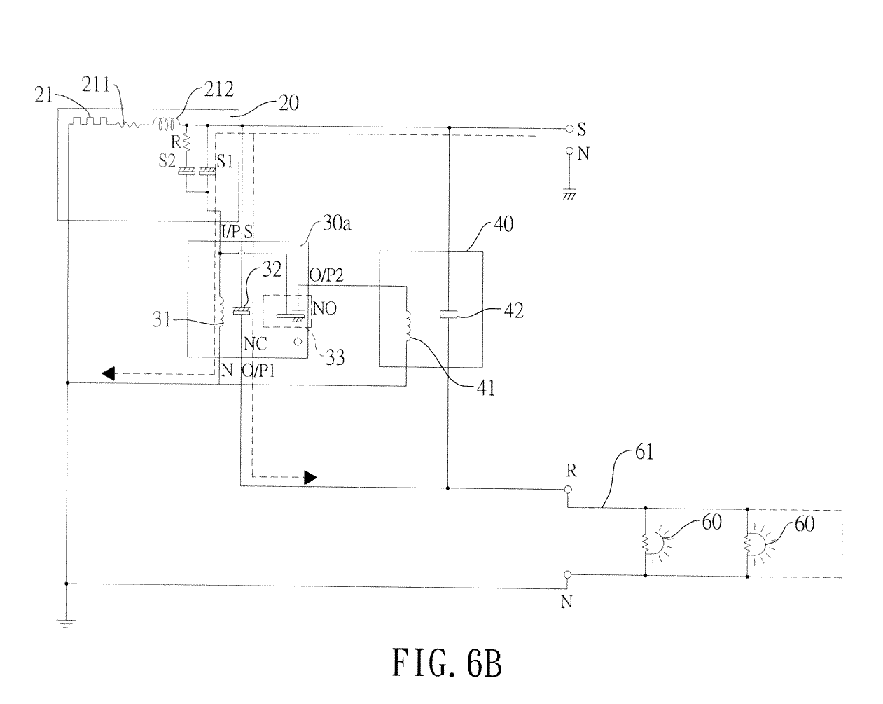

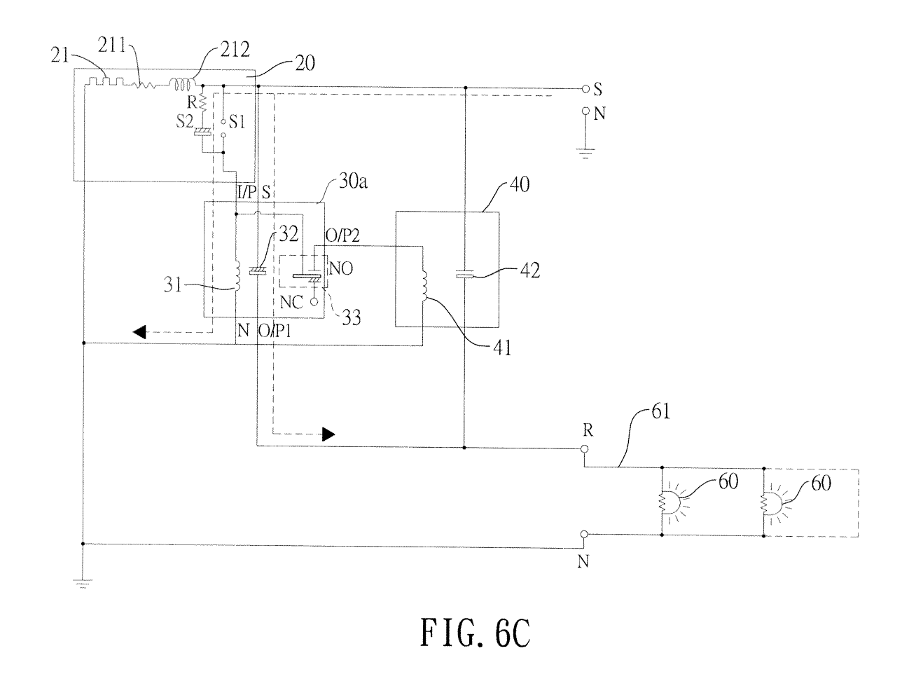

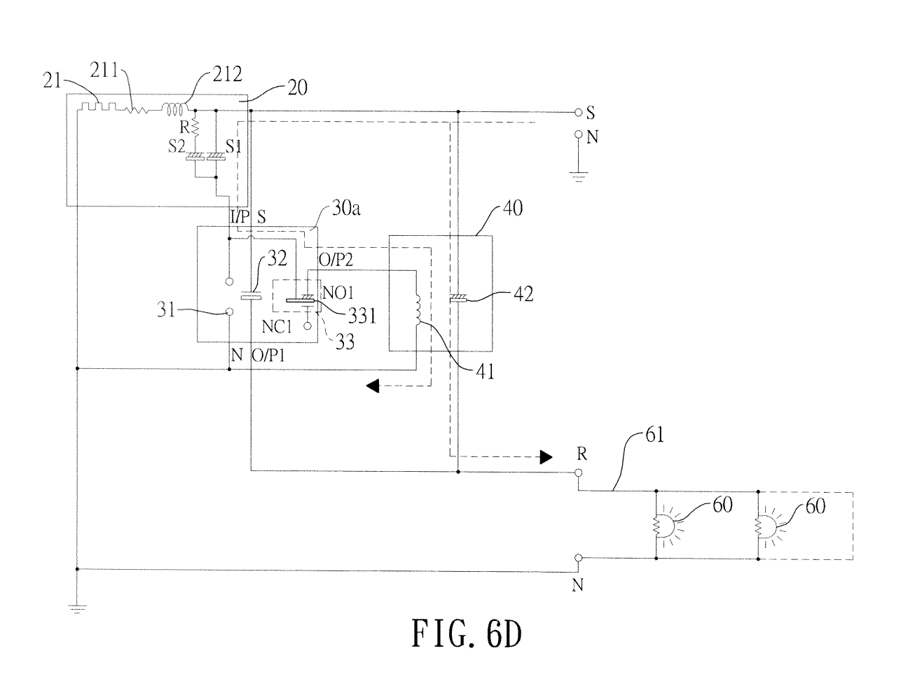

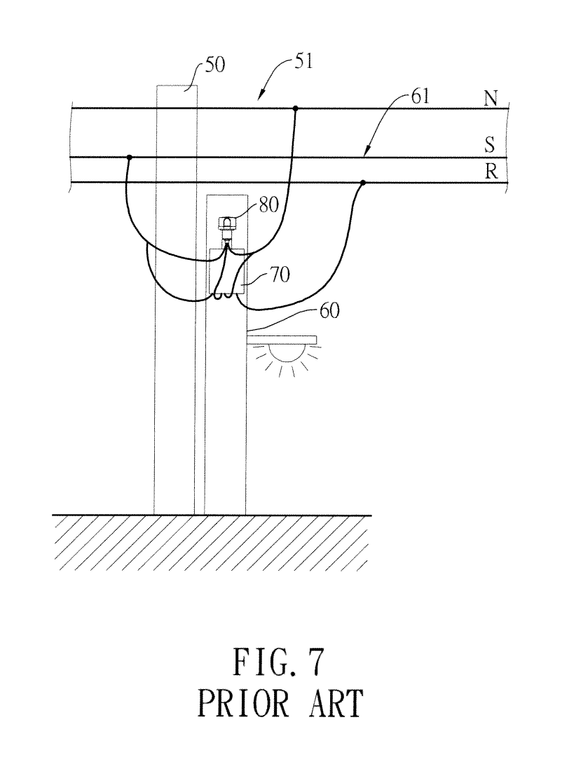

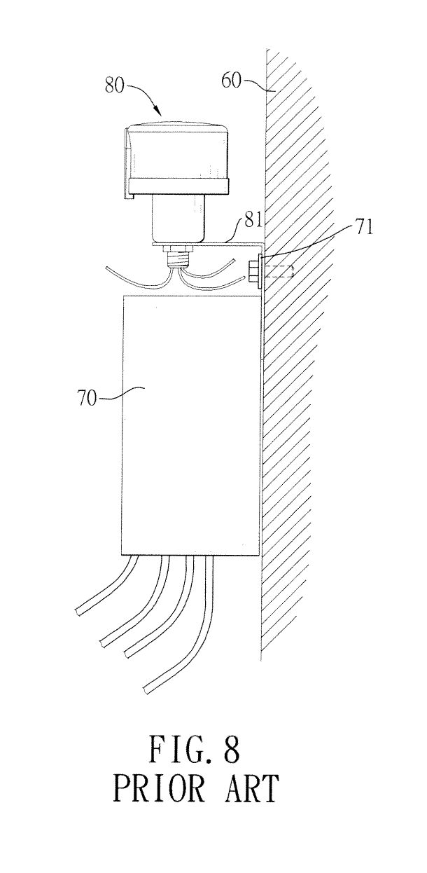

With reference to FIGS. 5 and 6A, a second embodiment of an uninterruptible photosensing power controller for streetlight in accordance with the present invention has a photosensing device 20 and a control box 10a.

The photosensing device 20 is the same as that of the first embodiment. The control box 10a is similar to that of the first embodiment except that the power device 30a further has a second switching unit 33 and the control box 10a further has an third switching unit 40. The second switching unit 33 has a transfer switch 331, a normally-open terminal NO and a normally-closed terminal NC. The transfer switch 331 is also activated by the first excitation coil 31 of the power switch 30a to selectively connect with the normally-open terminal NO or the normally-closed terminal NC. The third switching unit 40 has a third excitation coil 41 and a third switch 42. One end of the third excitation coil 41 is connected with the normally-open terminal NO of the second switching unit 33, and the other end is connected with the N line of the set of power cable connected to the streetlight 60. The third switch 42 is connected across the S line of the set of power cable connected to the utility pole and the R line of the set of power cable connected to the streetlight 60.

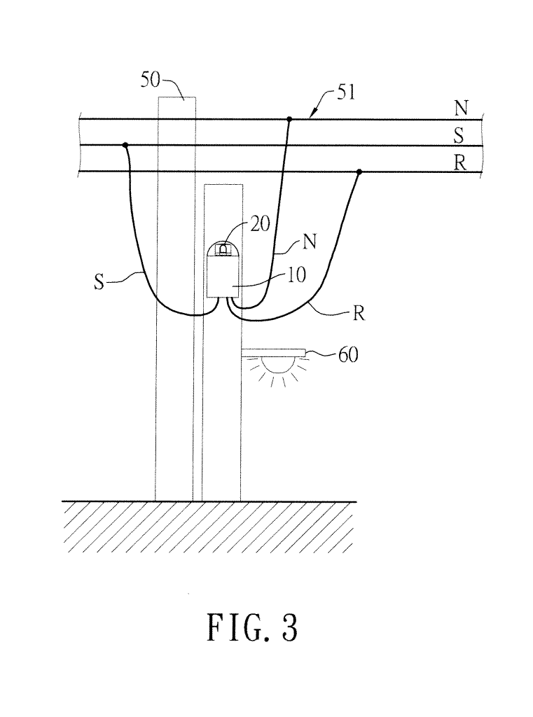

With reference to FIGS. 3 and 6A, the second embodiment of the uninterruptible photosensing power controller for streetlight is operated in the daytime. Because the resistance value of the photovaristor 21 is low, the power of the utility pole 50 is not inputted to the first excitation coil 31 of the power switch 30a, the first switching unit 32 is not switched on, and the transfer switch 331 of the second switching unit 33 is connected with the normally-open line NO. Accordingly, the streetlights 60 go off.

With reference to FIG. 6B, during nighttime, the resistance value of the photovaristor 31 increases and the current of the utility pole 50 is inputted to the first excitation coil 31 of the power switch 30a through the first switch S1. Thus, the first switching unit 32 is switched on, the power from the utility pole 50 is outputted to the streetlights 60, and the streetlights turn on. Meanwhile, the transfer switch 331 of the second switching unit 33 is activated by the first excitation coil 31 to connect with the normally-closed terminal NC and protect the power through the first switch from flowing in the streetlights 60 through the third switch 40, so that the second switching unit can be continuously switched on.

With reference to FIG. 6C, when the power of the utility pole 50 encounters a surge due to thunder and lightening and the first switch S1 breaks down, the second switch S2 remains intact due to the resistor R and switches on, and the transfer switch 331 of the second switching unit 33 is activated by the first excitation coil 31 to connect with the normally-closed terminal NC. Meanwhile, the current of the utility pole 50 is outputted to the first excitation coil 31 of the power switch 30a through the second switch S2, and the first switching unit 32 is switched on. Therefore, the power of the utility pole 50 is outputted to the streetlight 60 through the first switching unit 32, and the streetlight turns on. As the transfer switch 331 is connected with the normally-closed terminal NC, the power of the utility pole 50 is protected from flowing in the streetlight 60 through the third switch 40 so that the first switching unit 32 can be continuously switched on and the transfer switch 331 of the second switching unit 33 can be continuously connected with the normally-closed terminal NC.

With reference to FIG. 6D, when the first excitation coil 31 of the power switch 30a breaks down, the transfer switch 331 is connected with the normally-open terminal NO for sake of the unavailable first extraction coil 31. When the power of the utility pole 50 is outputted to the third excitation coil 41 through the first switch S1 and the second switching unit 33, the third switch 42 is activated by the third excitation coil 41 to switch on, the power from the utility pole is outputted to the streetlights 60 through the third switch 42, and the streetlights 60 turn on.

Given the socket 12 mounted on the control box 10 and electrically connected with the power switch 30 inside the control box 10, the photosensing device 20 can be directly plugged in and fixed on the control box 10, and electrically connected with the power switch 30 inside the control box 10. Consequently, installation workers only need to mount the photosensing device 20 on the control box 10 beforehand and fix the control box on the streetlight pole. Furthermore, installation workers just need to correctly connect the power cables of the control box 10 with the power lines of the utility pole 50 and the streetlight 60, thereby effectively simplifying the process and reducing labor of the installation. Moreover, the first switch S1 of the relay inside the photosensing device 20 is parallelly connected with the second switch S2 serially connected with a resistor. After the first switch S1 is damaged by a surge current, the second switch S2 provides a backup path to supply power to the streetlight 60 through the first switching unit 32. When the first excitation coil 31 of the power switch 30a breaks down, the power from the utility pole 50 flowing through the normally-open terminal NO of the second switching unit 33 activates the third switch 40 to switch on and supplies power to the streetlights 60 through the third switch 40. Accordingly, even if subjected to thunder and lightening and faulty conditions, the present invention can be continuously lighted up to safeguard passersby.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An uninterruptible photosensing power controller for streetlight, comprising:
a control box having:
a body;
a socket mounted on the body;
two sets of power cables mounted through the body; and
a power switch mounted inside the body, electrically connected with the socket and the two sets of power cables, and having a trigger terminal; and
a photosensing device plugged in the socket of the control box, electrically connected with the trigger terminal and one set of power cables through the socket, and triggering to switch the power switch in accordance with a luminance level of ambient light.

2. The uninterruptible photosensing power controller for streetlight as claimed in claim 1, wherein
the slot is mounted on a top of the body and has three plug holes;
the photosensing device has three blades mounted thereon, corresponding to the three plug holes and plugged in the three plug holes of the socket.

3. The uninterruptible photosensing power controller for streetlight as claimed in claim 1, wherein the socket is electrically connected with a trigger terminal of the power switch and one set of power cables.

4. The uninterruptible photosensing power controller for streetlight as claimed in claim 1, wherein the photosensing device has:
a relay having an excitation coil, and a first switch and a second switch parallelly connected between the excitation coil and the trigger terminal of the power switch, wherein the second switch is serially connected with a resistor; and
a photovaristor serially connected between the two sets of power cables through a resistor and the excitation coil of the relay.

5. The uninterruptible photosensing power controller for streetlight as claimed in claim 2, wherein the photosensing device has:
a relay having an excitation coil, and a first switch and a second switch parallelly connected between the excitation coil and the trigger terminal of the power switch, wherein the second switch is serially connected with a resistor; and
a photovaristor serially connected between the two sets of power cables through a resistor and the excitation coil of the relay.

6. The uninterruptible photosensing power controller for streetlight as claimed in claim 3, wherein the photosensing device has:
a relay having an excitation coil, and a first switch and a second switch parallelly connected between the excitation coil and the trigger terminal of the power switch, wherein the second switch is serially connected with a resistor; and
a photovaristor serially connected between the two sets of power cables through a resistor and the excitation coil of the relay.

7. The uninterruptible photosensing power controller for streetlight as claimed in claim 4, wherein the power switch further has:
a first switching unit connected between the two sets of power cables; and
a first excitation coil connected with the trigger terminal so as to connect with the first switch and the second switch of the photosensing device, and switching the first switching unit on with a current outputted from the first switch or the second switch.

8. The uninterruptible photosensing power controller for streetlight as claimed in claim 5, wherein the power switch further has:
a first switching unit connected between the two sets of power cables; and
a first excitation coil connected with the trigger terminal so as to connect with the first switch and the second switch of the photosensing device, and switching the first switching unit on with a current outputted from the first switch or the second switch.

9. The uninterruptible photosensing power controller for streetlight as claimed in claim 6, wherein the power switch further has:
a first switching unit connected between the two sets of power cables; and
a first excitation coil connected with the trigger terminal so as to connect with the first switch and the second switch of the photosensing device, and switching the first switching unit on with a current outputted from the first switch or the second switch.

10. The uninterruptible photosensing power controller for streetlight as claimed in claim 7, wherein
the power switch further has a second switching unit having a transfer switch, a normally-open terminal and a normally-closed terminal, wherein the transfer switch is connected with the trigger terminal and is activated by the first excitation coil of the power switch to selectively connect with the normally-open terminal or the normally-closed terminal; and
the control box further has a third switching unit having a third excitation coil connected with the normally-open terminal of the second switching unit and a third switch connected between the two sets of power cables.

11. The uninterruptible photosensing power controller for streetlight as claimed in claim 8, wherein
the power switch further has a second switching unit having a transfer switch, a normally-open terminal and a normally-closed terminal, wherein the transfer switch is connected with the trigger terminal and is activated by the first excitation coil of the power switch to selectively connect with the normally-open terminal or the normally-closed terminal; and
the control box further has a third switching unit having a third excitation coil connected with the normally-open terminal of the second switching unit and a third switch connected between the two sets of power cables.

12. The uninterruptible photosensing power controller for streetlight as claimed in claim 9, wherein
the power switch further has a second switching unit having a transfer switch, a normally-open terminal and a normally-closed terminal, wherein the transfer switch is connected with the trigger terminal and is activated by the first excitation coil of the power switch to selectively connect with the normally-open terminal or the normally-closed terminal; and
the control box further has a third switching unit having a third excitation coil connected with the normally-open terminal of the second switching unit and a third switch connected between the two sets of power cables.
